(19) United States
(12) Patent Application Publication
(10) Pub. No.: US 2026/0067924 A1
(43) Pub. Date: Mar. 5, 2026

(54) PAGING PHYSICAL DOWNLINK CONTROL CHANNEL MONITORING PROCESSING METHOD AND APPARATUS, AND RELATED DEVICE

(71) Applicant: VIVO MOBILE COMMUNICATION CO., LTD., Dongguan (CN)

(72) Inventors: Kai WU, Dongguan (CN); Lihui WANG, Dongguan (CN)

(73) Assignee: VIVO MOBILE COMMUNICATION CO., LTD., Dongguan (CN)

(21) Appl. No.: 19/383,070

(22) Filed: Nov. 7, 2025

Related U.S. Application Data
(63) Continuation of application No. PCT/CN2024/091296, filed on May 7, 2024.

(30) Foreign Application Priority Data
May 9, 2023 (CN) 202310524320.6

(51) Int. Cl. H04W 74/00; H04W 52/02; H04W 74/0833

(52) U.S. Cl. CPC H04W 74/006; H04W 74/0833; H04W 52/0229

(57) ABSTRACT

Provided are a paging physical downlink control channel monitoring processing method and apparatus, and a related device. The method includes: monitoring, by a terminal, a paging physical downlink control channel PDCCH based on a target monitoring occasion set when the terminal receives a wake up signal, where the target monitoring occasion set includes monitoring occasions in a target search space set, the target search space set includes a target PDCCH search space set, or the target search space set includes a target PDCCH search space set and a paging search space set, and the target PDCCH search space set includes at least one of the following: a PDCCH search space set for scheduling a system information block 1; a PDCCH search space set for scheduling a system information block other than the system information block 1; or a PDCCH search space set for scheduling a random access channel RACH response.

### CROSS-REFERENCE TO RELATED APPLICATIONS

This application is a continuation of International Patent Application No. PCT/CN2024/091296, filed on May 7, 2024, which claims priority to Chinese Patent Application No. 202310524320.6, filed in China on May 9, 2023, the entire contents of each of which are incorporated herein by reference for all purposes.

### TECHNICAL FIELD

This application pertains to the field of communication technologies, and specifically, relates to a paging physical downlink control channel monitoring processing method and apparatus, and a related device.

### BACKGROUND

With development of mobile communications, a low power wake up signal (LP-WUS) is received by a mobile communication terminal by introducing a low power wake up radio (LP-WUR), so that a primary communication module is in a disabled or sleep state, thereby effectively reducing power consumption of the terminal. In a related technology, after receiving the LP-WUS, the terminal usually needs to monitor a paging PDCCH on a paging occasion (PO) of a configured paging physical downlink control channel (paging Physical Downlink Control Channel, paging PDCCH).

### SUMMARY

Embodiments of this application provide a paging physical downlink control channel monitoring processing method and apparatus, and a related device.

According to a first aspect, a paging physical downlink control channel monitoring processing method is provided, including:
monitoring, by a terminal, a paging physical downlink control channel PDCCH based on a target monitoring occasion set when the terminal receives a wake up signal, where
the target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

According to a second aspect, a paging physical downlink control channel monitoring processing method is provided, including:
sending, by a network side device, a wake up signal to a terminal, where the wake up signal is used to indicate at least one of the following:
monitoring of a paging physical downlink control channel PDCCH based on a target monitoring occasion set; or
at least one search space set in the target monitoring occasion set, where the at least one search space set is used to monitor the paging PDCCH; and
the target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

According to a third aspect, a paging physical downlink control channel monitoring processing apparatus is provided, including:
a monitoring module, configured to monitor a paging physical downlink control channel PDCCH based on a target monitoring occasion set when a terminal receives a wake up signal, where
the target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

According to a fourth aspect, a paging physical downlink control channel monitoring processing apparatus is provided, including:
a sending module, configured to send a wake up signal to a terminal, where the wake up signal is used to indicate at least one of the following:
monitoring of a paging physical downlink control channel PDCCH based on a target monitoring occasion set; or
at least one search space set in the target monitoring occasion set, where the at least one search space set is used to monitor the paging PDCCH; and
the target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

According to a fifth aspect, a terminal is provided. The terminal includes a processor and a memory. The memory stores a program or instructions capable of running on the processor, and the program or the instructions are executed by the processor to implement the steps of the method according to the first aspect.

According to a sixth aspect, a terminal is provided, including a processor and a communication interface. The communication interface is configured to monitor a paging physical downlink control channel PDCCH based on a target monitoring occasion set when a terminal receives a wake up signal, where
the target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

According to a seventh aspect, a network side device is provided. The network side device includes a processor and a memory. The memory stores a program or instructions capable of running on the processor, and the program or the instructions are executed by the processor to implement the steps of the method according to the second aspect.

According to an eighth aspect, a network side device is provided, including a processor and a communication interface. The communication interface is configured to send a wake up signal to a terminal, and the wake up signal is used to indicate at least one of the following:
monitoring of a paging physical downlink control channel PDCCH based on a target monitoring occasion set; or
at least one search space set in the target monitoring occasion set, where the at least one search space set is used to monitor the paging PDCCH; and
the target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

According to a ninth aspect, a readable storage medium is provided. The readable storage medium stores a program or instructions, and when the program or the instructions are executed by a processor, the steps of the method according to the first aspect are implemented, or the steps of the method according to the second aspect are implemented.

According to a tenth aspect, a wireless communication system is provided, including a terminal and a network side device. The terminal may be configured to perform the steps of the method according to the first aspect, and the network side device may be configured to perform the steps of the method according to the second aspect.

According to an eleventh aspect, a chip is provided. The chip includes a processor and a communication interface. The communication interface is coupled to the processor, and the processor is configured to run a program or instructions to implement the method according to the first aspect, or to implement the method according to the second aspect.

According to a twelfth aspect, a computer program/program product is provided. The computer program/program product is stored in a storage medium, and the program/program product is executed by at least one processor to implement the steps of the method according to the first aspect or the method according to the second aspect.

In embodiments of this application, the terminal monitors the paging physical downlink control channel PDCCH based on the target monitoring occasion set when the terminal receives the wake up signal, where the target monitoring occasion set includes the monitoring occasions in the target search space set, the target search space set includes the target PDCCH search space set, or the target search space set includes the target PDCCH search space set and the paging search space set, and the target PDCCH search space set includes at least one of the following: the PDCCH search space set for scheduling a system information block 1; the PDCCH search space set for scheduling a system information block other than the system information block 1; or the PDCCH search space set for scheduling a random access channel RACH response.

### BRIEF DESCRIPTION OF DRAWINGS

FIG. 1 is a schematic structural diagram of a network applicable to this application;

FIG. 2 is a principle diagram of waking up a terminal according to an embodiment of this application;

FIG. 3 is a schematic flowchart of a paging physical downlink control channel monitoring processing method according to an embodiment of this application;

FIG. 4 is a schematic diagram of monitoring a paging PDCCH in a paging physical downlink control channel monitoring processing method according to an embodiment of this application;

FIG. 5 is another schematic diagram of monitoring a paging PDCCH in a paging physical downlink control channel monitoring processing method according to an embodiment of this application;

FIG. 6 is still another schematic diagram of monitoring a paging PDCCH in a paging physical downlink control channel monitoring processing method according to an embodiment of this application;

FIG. 7 is a schematic flowchart of another paging physical downlink control channel monitoring processing method according to an embodiment of this application;

FIG. 8 is a schematic structural diagram of a paging physical downlink control channel monitoring processing apparatus according to an embodiment of this application;

FIG. 9 is a schematic structural diagram of another paging physical downlink control channel monitoring processing apparatus according to an embodiment of this application;

FIG. 10 is a schematic structural diagram of a communication device according to an embodiment of this application;

FIG. 11 is a schematic structural diagram of a terminal according to an embodiment of this application; and

FIG. 12 is a schematic structural diagram of a network side device according to an embodiment of this application.

### DESCRIPTION OF EMBODIMENTS

The terms “first”, “second”, and the like in this application are used to distinguish between similar objects instead of describing a specified order or sequence. It should be understood that terms used in this way are interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, a solution 1: including A and not including B; a solution 2: including B and not including A; and a solution 3: including both A and B. The character “/” generally represents an “or” relationship between associated objects.

The term “indication” in this application may be either a direct indication (or an explicit indication) or an indirect indication (or an implicit indication). The direct indication may be understood as: A sender explicitly notifies, in a sent indication, a receiver of specific information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed or the requested result.

It should be noted that, a technology described in embodiments of this application is not limited to a Long Term Evolution (LTE)/LTE-advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency-Division Multiple Access (SC-FDMA) system, or another system. The terms “system” and “network” are often used interchangeably in the embodiments of this application. The technology described may be used for the systems and radio technologies described above, as well as other systems and radio technologies. The following describes a New Radio (NR) system for illustrative purposes, and NR terms are used in most of the following descriptions. However, these technologies are also applicable to systems such as a 6th Generation (6G) communication system other than the NR system.

Because a cycle of the PO is relatively long, a paging latency (latency) is relatively long. Embodiments of this application provide a paging physical downlink control channel monitoring processing method and apparatus, and a related device, to resolve a problem that a paging latency is relatively long because a cycle of a PO is relatively long. The target PDCCH search space set does not need to be distinguished for the terminal, and a cycle of monitoring occasions included in the target PDCCH search space set is relatively short. Therefore, a monitoring latency of the paging PDCCH can be reduced by monitoring the paging PDCCH by the terminal based on the target PDCCH search space set.

FIG. 1 is a block diagram of a wireless communication system applicable to an embodiment of this application. The wireless communication system includes a terminal 11 and a network side device 12. The terminal 11 may be a mobile phone, a tablet personal computer, a laptop computer, a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, a flight vehicle, Vehicle User Equipment (VUE), ship-mounted equipment, Pedestrian User Equipment (PUE), a smart home (a home device with a wireless communication function, for example, a refrigerator, a television, a laundry machine, or a furniture), a gaming console, a personal computer (PC), a teller machine, a self-service machine, or another terminal side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AS), a Wireless Fidelity (WiFi) node, or the like. The base station may be referred to as a NodeB (NB), an Evolved NodeB (eNB), the next generation NodeB (gNB), a New Radio NodeB (NR NodeB), an access point, a Relay Base Station (RBS), a Serving Base Station, (SBS), a Base Transceiver Station (BTS), a radio base station, a radio transceiver, a Basic Service Set (BSS), an Extended Service Set (ESS), a home NodeB (HNB), a home evolved NodeB, a Transmission Reception Point (TRP), or another proper term in the field. The base station is not limited to a specific technical term, provided that the same technical effect is achieved. It should be noted that in the embodiments of this application, only a base station in an NR system is used as an example for description, and a specific type of the base station is not limited.

For ease of understanding, the following describes some content related to the embodiments of this application.

### I. Low Power Radio

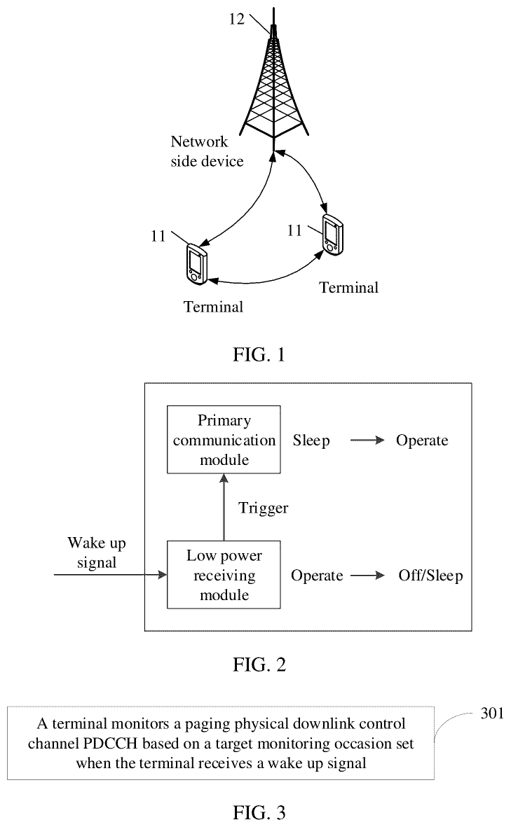

The low power radio may be referred to as an LP-WUR or an almost zero power wake up radio (AZP-WUR). A basic operating principle of the LP-WUR is that a receive end includes a first module and a second module, the first module is a primary communication module and is configured to send/receive mobile communication data, and the second module is a low power receiving module (also referred to as a low power wake up receiving module) and is configured to receive the foregoing wake up signal, which is specifically shown in FIG. 2. In an energy-saving state, a terminal enables the low power receiving module to monitor the LP-WUS, and disables the primary communication module. When downlink data arrives, a network side device sends a wake up signal to the terminal. After monitoring the wake up signal by using the low power receiving module, the terminal triggers the primary communication module after a series of determining, to change from a disabled state to an enabled state. In this case, the low power receiving module enters the disabled state from an operating state. The low power wake up receiving module may be continuously enabled or intermittently enabled, and may receive a low power wake up signal when being enabled.

### 2. Low Power Wake Up Signal (WUS)

To reduce a receiving activity of a terminal in a standby state, so that a Radio Frequency (RF) module and a baseband (MODEM) module are truly disabled, and communication receiving power consumption is greatly reduced, an almost “zero” power radio may be introduced into a receiving module of the terminal. The almost “zero” power radio does not require complex signal detection (such as amplification, filtering, and quantization) by the RF module and signal processing by the modem, and can only depend on passive matched filtering and low power signal processing.

On a base station side, a wake up signal is triggered on-demand, so that the almost “zero” power radio can be activated to learn of an activation advertisement, thereby triggering a series of procedures inside the terminal, for example, enabling a radio frequency transceiver module and a baseband processing module.

Generally, the wake up signal is a relatively simple on-off keying signal. In this way, the radio can learn of a wake up advertisement by using a process such as simple energy detection and subsequent possible sequence detection and identification. In addition, while the terminal enables a low power wake up radio to receive the wake up signal, a primary receiving module may maintain operating at a relatively low power level, thereby implementing power saving by receiving the wake up signal.

Receiving of the low power wake up signal may be applied to a terminal in a Radio Resource Control (RRC) idle (RRC_idle)/inactive state, or may be applied to a terminal in an RRC_connected (RRC_connected) state, thereby implementing energy saving of the terminal.

In an embodiment, the wake up signal mentioned in this application is the wake up signal received by the low power radio.

### 3. a Behavior of Monitoring Paging by a Terminal

A PO on which a monitoring occasion of monitoring a paging PDCCH by a terminal is determined based on a terminal identifier, and is related to a Discontinuous Reception (DRX) cycle.

After receiving an LP-WUS, the terminal needs to first receive a synchronization signal block (Synchronization Signal and PBCH block, SSB), to perform downlink time and frequency synchronization. Only after completing Automatic Gain Control (AGC) and time and frequency synchronization, the terminal can reliably receive subsequent paging PDCCH and a paging Physical downlink shared channel (PDSCH).

There are two latencies from receiving the LP-WUS by the terminal to monitoring the paging PDCCH:

A latency 1 is from a time t1 of LP-WUS reception and wake up detection to a time T2 at which the terminal may monitor the paging PDCCH, which includes a time of enabling main radio hardware and a time of receiving an SSB.

A latency 2 is from a time t2 at which the terminal may monitor the paging PDCCH to a time t3 of a PO on which the terminal monitors the paging PDCCH in a related mechanism.

In the foregoing two latencies, the latency 1 cannot be further reduced, and the latency 2 may be further optimized, to reduce an overall paging latency.

### 4. Parameter Configuration Required for Monitoring a Paging PDCCH

A terminal in an idle state camps on a cell, and monitors a paging PDCCH. The terminal requires some network configuration information for monitoring the paging PDCCH, including a configuration of an SSB, a configuration of an idle DRX cycle (paging cycle), an uplink-downlink configuration of Time Division Duplex (TDD), and a configuration of a paging search space set, and the like. These configurations are transmitted in a System Information Block (SIB). In other words, the terminal receives the paging PDCCH only when the terminal receives the SIB by using a main radio. The terminal determines a paging PDCCH monitoring occasion corresponding to each SSB based on the SSB and an uplink/downlink configuration, and performs monitoring on all or some monitoring occasions.

After reselecting a new camped-on cell, the terminal receives the paging PDCCH in the new cell, and also needs to receive an SIB of the new camped-on cell. That is, in a related technology, after reselection, the terminal needs to enable the main radio to receive an SIB. Enabling the main radio to perform reselection and receive the SIB improves power consumption of the terminal.

5. Process in which an Idle Terminal Monitors an SIB 1

To access a network, a terminal first performs a cell search, searches for an SSB sent by a base station, completes downlink synchronization by using a synchronization signal in the SSB, and obtains a Master Information Block (MIB) from a Physical broadcast channel (PBCH) in the SSB. The MIB includes configuration information of a monitoring occasion of monitoring a PDCCH for scheduling SIB 1. That is, for monitoring of such a type of PDCCH, the PDCCH may be monitored when no subsequent SIB provides configuration information. A process in which the terminal receives the PBCH to obtain the MIB may be completed while the SSB is received to perform downlink synchronization.

A paging physical downlink control channel monitoring processing method provided in embodiments of this application is described in detail below with reference to the accompanying drawing by using some embodiments and application scenarios thereof.

As shown in FIG. 3, an embodiment of this application provides a paging physical downlink control channel monitoring processing method. As shown in FIG. 3, the paging physical downlink control channel monitoring processing method includes:
Step 301: A terminal monitors a paging physical downlink control channel PDCCH based on a target monitoring occasion set when the terminal receives a wake up signal.

The target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

In this embodiment of this application, the PDCCH search space set for scheduling a system information block other than the system information block 1 may be understood as a PDCCH search space set for scheduling another SIB. The another SIB may be an SIB X, where X>1.

Optionally, the target search space set may be configured by a network side device.

It should be understood that, that a monitoring latency of the paging PDCCH can be reduced by monitoring the paging PDCCH based on the target PDCCH search space set by the terminal lies in at least one of the following:
the target PDCCH search space set does not need to be distinguished for the terminal;
a cycle of monitoring occasions included in the target PDCCH search space set is relatively short, for example, in some embodiments, the cycle of the monitoring occasions in the target PDCCH search space set is less than a cycle of monitoring occasions in the paging search space set; or
when the paging PDCCH is monitored based on at least two search space sets, the paging PDCCH may be monitored on one or more of the foregoing monitoring occasions.

In embodiments of this application, the terminal monitors the paging physical downlink control channel PDCCH based on the target monitoring occasion set when the terminal receives the wake up signal, where the target monitoring occasion set includes the monitoring occasions in the target search space set, the target search space set includes the target PDCCH search space set, or the target search space set includes the target PDCCH search space set and the paging search space set, and the target PDCCH search space set includes at least one of the following: the PDCCH search space set for scheduling a system information block 1; the PDCCH search space set for scheduling a system information block other than the system information block 1; or the PDCCH search space set for scheduling a random access channel RACH response. The target PDCCH search space set does not need to be distinguished for the terminal, and the cycle of the monitoring occasions included in the target PDCCH search space set is relatively short. Therefore, the monitoring latency of the paging PDCCH can be reduced by monitoring the paging PDCCH by the terminal based on the target PDCCH search space set.

Optionally, in some embodiments, that the terminal monitors the paging physical downlink control channel PDCCH based on the target monitoring occasion set includes:
The terminal monitors the paging physical downlink control channel PDCCH on a target monitoring occasions in the target monitoring occasion set.

The target monitoring occasions meet at least one of the following:
the target monitoring occasions are monitoring occasions after a first moment, the first moment is after a second moment at which the terminal receives the wake up signal, and an interval between the first moment and the second moment is predetermined duration; or
the target monitoring occasions are monitoring occasions corresponding to all synchronization signal blocks in a target synchronization signal block set, and a target synchronization signal block is a synchronization signal block specified in a protocol or indicated by the network side device.

In this embodiment of this application, the predetermined duration may be understood as a time interval from receiving the wake up signal to receiving the PDCCH. Optionally, in some embodiments, a time period between the first moment and the second moment may include at least one of the following: a time of enabling a primary communication module, a time of receiving an SSB, a completion time, a frequency synchronization time, or a time of completing AGC. In other words, the first moment may indicate a start moment at which the terminal may monitor the paging PDCCH. In this way, because the paging PDCCH starts to be monitored at the start moment at which the paging PDCCH may be monitored, to further reduce the monitoring latency of the paging PDCCH.

In some embodiments, the target synchronization signal block set may include an SSB 0, an SSB 1, . . . , and an SSB (X−1), where X is a maximum quantity of SSBs on a band on which the terminal operates.

Optionally, in some embodiments, the target monitoring occasions further meet:
the target monitoring occasions are first N monitoring occasions starting from the first moment.

Herein, N is a positive integer.

In this embodiment of this application, the first N monitoring occasions starting from the first moment may be understood as first N monitoring occasions arranged in a time sequence in all monitoring occasions after the first moment. Because the paging PDCCH is monitored on the first N monitoring occasions, the monitoring latency of the paging PDCCH can be further reduced.

Optionally, in some embodiments, the wake up signal is used to indicate at least one of the following:
monitoring the paging PDCCH by the terminal based on the target monitoring occasion set; or
at least one search space set in the target monitoring occasion set, where the at least one search space set is used to monitor the paging PDCCH.

Optionally, that the wake up signal indicates the at least one search space set in the target monitoring occasion set may be understood as that the wake up signal configures the at least one search space set in the target monitoring occasion set, or may be understood as that the wake up signal activates the at least one search space set in the target monitoring occasion set.

In this embodiment of this application, the network side device may indicate, by using the wake up signal, monitoring of the paging PDCCH by the terminal based on the target monitoring occasion set and the at least one search space set in the target monitoring occasion set. In this way, flexibility of monitoring the paging PDCCH can be improved.

Optionally, in some embodiments, that the terminal monitors the paging physical downlink control channel PDCCH based on the target monitoring occasion set when the terminal receives the wake up signal includes:

The terminal monitors the paging PDCCH on the target monitoring occasions in the target monitoring occasion set, where the target monitoring occasions are determined based on a target time period, and a start moment of the target time period is any one of the following:
a time at which the terminal receives a target signal most recently; and
a time of uplink sending triggered by the target signal received by the terminal most recently; and
the target signal is a radio resource control RRC release signal, a paging signal, or a wake up signal.

Optionally, the time at which the terminal receives the target signal most recently may be understood as an end moment corresponding to a time unit in which the terminal receives the target signal most recently or may be understood as a receiving moment at which the terminal receives the target signal most recently. The time of uplink sending triggered by the target signal received by the terminal most recently may be understood as a start moment or an end moment of uplink sending triggered by the target signal received by the terminal most recently, or may be understood as a start moment or an end moment of a time unit of uplink sending triggered by the target signal received by the terminal most recently. The time unit may be a slot, a sub-slot, a frame, a subframe, or the like, which is not further limited herein.

Optionally, the foregoing uplink sending may include a Physical Uplink Control Channel (PUCCH), a Physical Uplink Shared Channel (PUSCH), a Physical Random Access Channel (PRACH), and the like. A time length of the target time period may be specified in a protocol, or may be configured by the network side device, which is not further limited herein.

Optionally, in some embodiments, the target monitoring occasions meet at least one of the following:
in the target time period, the target monitoring occasions are monitoring occasions in the paging search space set; or
after an end moment of the target time period, the target monitoring occasions are monitoring occasions in the PDCCH search space set for scheduling the system information block 1.

Optionally, in some embodiments, before the terminal monitors the paging physical downlink control channel PDCCH based on the target monitoring occasion set, the method further includes:

After the terminal receives the wake up signal, the terminal obtains, from a physical broadcast channel, the PDCCH search space set for scheduling the system information block 1.

In this embodiment of this application, after receiving the wake up signal, the terminal may perform a cell handover. Therefore, after receiving the wake up signal and before monitoring the paging PDCCH, the terminal obtains, from the physical broadcast channel, the PDCCH search space set for scheduling a system information block 1, thereby ensuring validity of the PDCCH search space set for scheduling the system information block 1, and further improving reliability of monitoring the paging PDCCH.

For better understanding of this application, the following provides detailed descriptions by using some embodiments.

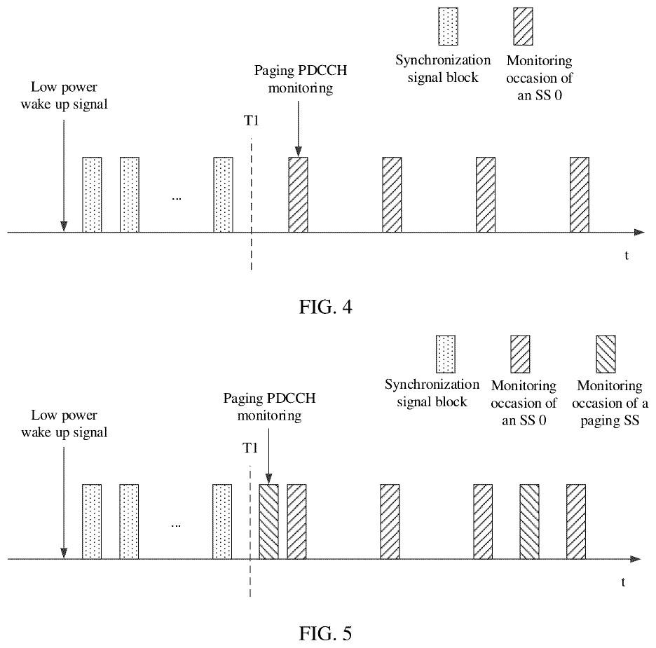

In some embodiments, as shown in FIG. 4, after receiving an LP-WUS that indicates to monitor the paging PDCCH, the terminal receives the SSB to complete AGC and downlink time and frequency synchronization and complete demodulation of a PBCH. The terminal may need to receive a plurality of SSBs to complete the foregoing operations. A latency of completing the foregoing operations is T1. After the time T1 (namely, the first moment), the terminal may perform monitoring based on the PDCCH search space set (namely, an SS #0) for scheduling the SIB 1 in a first search space set.

The terminal may monitor the paging PDCCH on an earliest monitoring occasion after the time T1.

Optionally, if the terminal still reserves a configuration of a paging PDCCH monitoring occasion, the terminal may monitor the paging PDCCH on an earliest monitoring occasion in the PDCCH search space set for scheduling the SIB 1 and the paging search space set, as shown in FIG. 5.

Further, after the time T1, in addition to the PDCCH search space set for scheduling the SIB 1, a search space for monitoring the paging PDCCH by the terminal may be a PDCCH search space set for scheduling Other System Information (OSI) (the SIB X, where X>1), and a PDCCH search space set for scheduling a random access response. The terminal may monitor the paging PDCCH on one or more earliest monitoring occasions in these search space sets.

According to the foregoing method, the following advantages can be obtained:

A paging latency is reduced, and a cycle of the PDCCH for scheduling the SIB 1 is relatively short, for example, 20 ms, and is far less than a paging monitoring cycle. In this way, a paging latency of the paging PDCCH can be reduced. If it is further considered that a plurality of search spaces may be used for receiving of the paging PDCCH, the paging latency may be further reduced.

If the terminal maintains and reserves a valid system information configuration, the terminal may perform monitoring based on a plurality of search space sets such as the PDCCH search space set for scheduling the SIB 1, the PDCCH search space set for scheduling the SIB X, where X>1, the PDCCH search space set for scheduling the random access response, and the paging search space set.

If the terminal does not maintain the SIB, the terminal may obtain a configuration of one search space set by using an MIB, namely, the PDCCH search space set for scheduling the SIB 1. For example, after the terminal enters coverage of another cell, the terminal may not enable a main radio to receive the SIB and perform cell reselection, provided that after receiving the wake up signal, the terminal searches for and receives the SSB, and receives the paging PDCCH based on MIB information in the SSB. In this way, unnecessary enabling of the main radio can be avoided, thereby reducing overall power consumption of the terminal. In this case, the terminal may determine, by using the LP-WUS or another signal received based on a WUR, whether a cell change occurs, and continue to monitor the LP-WUS in a new cell, to avoid using the main radio to perform reselection or receive the SIB.

In some embodiments, a complete PDCCH monitoring occasion set may be determined, to avoid monitoring only paging PDCCH monitoring occasions corresponding to some beams.

For example, in control information carried in the LP-WUS, the network side device may indicate the monitoring occasion of monitoring the paging PDCCH. Preferably, the indicated monitoring occasion is one or more of the foregoing search space sets. Because UE that enables the WUR to receive the LP-WUS may not perform SIB maintenance and updating, and does not learn of whether the network side device performs system information updating and changes an existing configuration of the search space set, generally, it cannot be assumed that the configuration of these search space sets is still valid.

However, a system message change is also a small probability event for a network side, and an existing network does not frequently perform system information updating. The network side device may indicate, to the terminal, the search space set for monitoring the paging PDCCH based on whether system information updating occurs within a period of time.

If no system information change occurs, a system information configuration previously stored in the terminal is still valid, and the network side device may indicate to receive the paging PDCCH based on one or more of search space sets in the previous system information configuration. If a system information change occurs and the previous search space configuration is no longer valid, the network side device may indicate the terminal to monitor the paging PDCCH based on the search space set for scheduling the SIB 1. After receiving the SSB, the terminal obtains the search space configuration information, and monitors the paging PDCCH.

It should be understood that, for the foregoing solution, the terminal can receive the paging PDCCH based on the indication of the LP-WUS only when the terminal maintains the system information configuration when camping on the cell or reselecting the cell, and maintains at least the search space configurations in system information. In this way, as long as cell reselection does not occur, the terminal may not need to maintain the SIB, thereby reducing power consumption of the terminal.

In some embodiments, a complete PDCCH monitoring occasion set may be determined, to avoid monitoring only the paging PDCCH monitoring occasions corresponding to some beams.

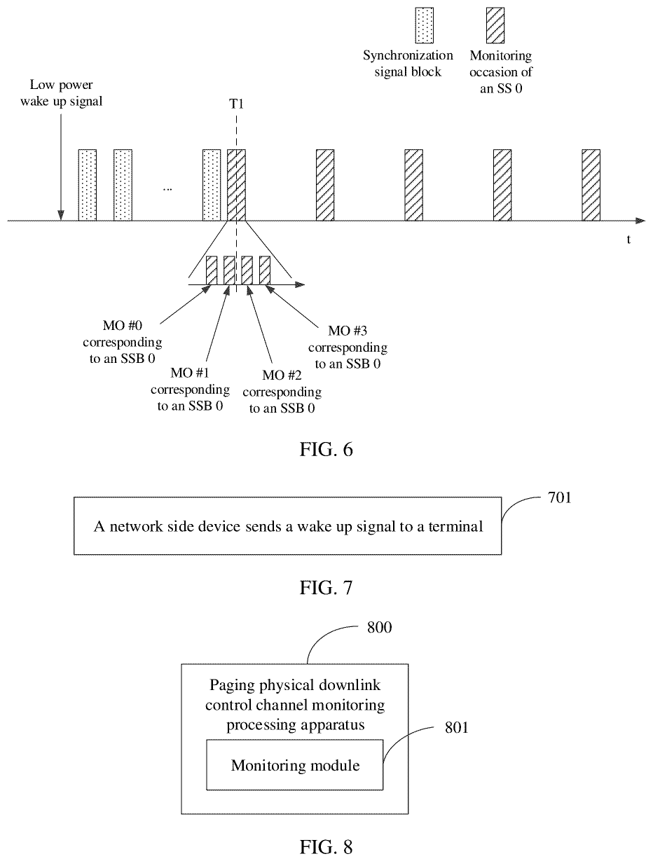

As shown in FIG. 6, some of paging monitoring occasions corresponding to the earliest search space set may be before the time T1, and some are after the time T1.

In a related technology, the paging needs to be sent on a beam corresponding to the SSB, and the terminal also needs to receive the paging PDCCH on monitoring occasions corresponding to all SSBs. If monitoring occasions corresponding to some SSBs are before the time T1, the terminal cannot monitor the monitoring occasion(s), and receiving reliability of the paging PDCCH cannot be ensured.

To ensure that the terminal may monitor the paging PDCCH on the MOs corresponding to all the SSBs, it may be further determined that the paging PDCCH is received on monitoring occasions of PDCCHs corresponding to all SSBs sent by a cell after the time T1. Details may be as follows:

After the time T1, a monitoring occasion of the paging PDCCH starts to be determined from a PDCCH monitoring occasion corresponding to a 1st SSB 0.

After the time T1, a monitoring occasion of the paging PDCCH starts to be determined from a PDCCH monitoring occasion corresponding to an SSB with a lowest SSB index value. The SSB with the lowest SSB index value is an SSB with a lowest index value in the SSBs sent by the cell, or an SSB with a lowest index value in SSBs detected by the terminal.

The monitoring occasion of the paging PDCCH corresponding to the SSB and an index of the SSB are in a one-to-one mapping manner in ascending order. After a 1st paging PDCCH monitoring occasion is determined in the foregoing method, paging PDCCH monitoring occasions corresponding to all the SSBs may be determined.

In this embodiment of this application, a monitoring occasion set of monitoring the paging PDCCH by the terminal includes monitoring occasions of PDCCHs corresponding to all the SSBs, to ensure monitoring reliability of the paging PDCCH.

The terminal may determine monitoring occasions of a plurality of paging PDCCHs corresponding to a plurality of SSBs starting from the determined monitoring occasion of the 1 st paging PDCCH. The terminal may determine, based on an implementation, whether to monitor monitoring occasions of all paging PDCCHs or monitoring occasions of some paging PDCCHs.

It should be understood that in this embodiment of this application, the terminal may receive the paging PDCCH on transmission occasions corresponding to a plurality of beams, to ensure transmission reliability.

Optionally, in some embodiments, a time for receiving the paging PDCCH is determined based on a time after RRC release is received.

In this embodiment of this application, to avoid a case in which idle UE needs to perform periodic SIB receiving, the terminal may only need to assume that a current SIB is valid within preset time D2 (that is, the foregoing target time period) starting from T2, and still monitor the paging PDCCH monitoring based on the paging search space set. If the preset time D2 starting from T2 expires, the UE assumes that the SIB in this case is no longer valid, and monitors the paging PDCCH based on the PDCCH search space set for scheduling the SIB 1.

Optionally, the preset time D2 includes a time of receiving the RRC release signal by the UE, a time of previous reception of the LP-WUS by the terminal, a time of previous reception of the paging signal by the terminal, or a time of uplink sending triggered by sending the foregoing signal by the terminal. The uplink sending may be a PUCCH, a PUSCH, a PRACH, or the like. D2 is predefined or configured by the network side device.

As shown in FIG. 7, an embodiment of this application further provides a paging physical downlink control channel monitoring processing method. As shown in FIG. 7, the paging physical downlink control channel monitoring processing method includes:
Step 701: A network side device sends a wake up signal to a terminal, where the wake up signal is used to indicate at least one of the following:
monitoring of a paging physical downlink control channel PDCCH based on a target monitoring occasion set; or
at least one search space set in the target monitoring occasion set, where the at least one search space set is used to monitor the paging PDCCH.

The target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

Optionally, the method further includes:

The terminal sends, based on a physical broadcast channel, the PDCCH search space set for scheduling the system information block 1.

The paging physical downlink control channel monitoring processing method provided in this embodiment of this application may be performed by a paging physical downlink control channel monitoring processing apparatus. In this embodiment of this application, an example in which the paging physical downlink control channel monitoring processing apparatus performs the paging physical downlink control channel monitoring processing method is used to describe the paging physical downlink control channel monitoring processing apparatus provided in this embodiment of this application.

As shown in FIG. 8, an embodiment of this application further provides a paging physical downlink control channel monitoring processing apparatus. As shown in FIG. 8, the paging physical downlink control channel monitoring processing apparatus 800 includes:
a monitoring module 801, configured to monitor a paging physical downlink control channel PDCCH based on a target monitoring occasion set when a terminal receives a wake up signal.

The target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

Optionally, the monitoring module 801 is specifically configured to monitor the paging PDCCH on a target monitoring occasions in the target monitoring occasion set.

The target monitoring occasions meet at least one of the following:
the target monitoring occasions are monitoring occasions after a first moment, the first moment is after a second moment at which the terminal receives the wake up signal, and an interval between the first moment and the second moment is predetermined duration; or
the target monitoring occasions are monitoring occasions corresponding to all synchronization signal blocks in a target synchronization signal block set, and a target synchronization signal block is a synchronization signal block specified in a protocol or indicated by a network side device.

Optionally, the target monitoring occasions further meet:
the target monitoring occasions are first N monitoring occasions starting from the first moment.

Herein, N is a positive integer.

Optionally, the wake up signal is used to indicate at least one of the following:
monitoring the paging PDCCH by the terminal based on the target monitoring occasion set; or
at least one search space set in the target monitoring occasion set, where the at least one search space set is used to monitor the paging PDCCH.

Optionally, the monitoring module 801 is specifically configured to monitor the paging PDCCH on the target monitoring occasions in the target monitoring occasion set, where the target monitoring occasions are determined based on a target time period, and a start moment of the target time period is any one of the following:
a time at which the terminal receives a target signal most recently; and
a time of uplink sending triggered by the target signal received by the terminal most recently.

The target signal is a radio resource control RRC release signal, a paging signal, or a wake up signal.

Optionally, the target monitoring occasions meet at least one of the following:
in the target time period, the target monitoring occasions are monitoring occasions in the paging search space set; or
after an end moment of the target time period, the target monitoring occasions are monitoring occasions in the PDCCH search space set for scheduling the system information block 1.

Optionally, the paging physical downlink control channel monitoring processing apparatus 800 further includes:
an obtaining module, configured to: after the terminal receives the wake up signal, obtain, from a physical broadcast channel, the PDCCH search space set for scheduling the system information block 1.

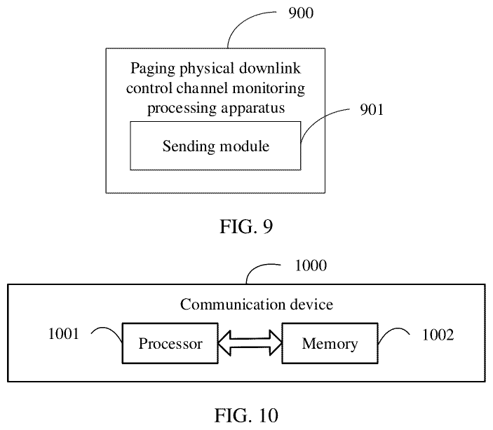

As shown in FIG. 9, an embodiment of this application further provides a paging physical downlink control channel monitoring processing apparatus. As shown in FIG. 9, the paging physical downlink control channel monitoring processing apparatus 900 includes:
a sending module 901, configured to send a wake up signal to a terminal, where the wake up signal is used to indicate at least one of the following:
monitoring of a paging physical downlink control channel PDCCH based on a target monitoring occasion set; or
at least one search space set in the target monitoring occasion set, where the at least one search space set is used to monitor the paging PDCCH.

The target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

Optionally, the sending module 901 is further configured to send, based on a physical broadcast channel, the PDCCH search space set for scheduling the system information block 1.

The paging physical downlink control channel monitoring processing apparatus in this embodiment of this application may be an electronic device, for example, an electronic device with an operating system, or may be a component, for example, an integrated circuit or a chip, in an electronic device. The electronic device may be a terminal, or may be a device other than the terminal. For example, the terminal may include but is not limited to the foregoing listed types of the terminal 11. The another device may be a server, a Network Attached Storage (NAS), or the like. This is not specifically limited in this embodiment of this application.

The paging physical downlink control channel monitoring processing apparatus provided in this embodiment of this application can implement the processes implemented in the method embodiments of FIG. 3 to FIG. 7, and achieve same technical effects. To avoid repetition, details are not described herein again.

As shown in FIG. 10, an embodiment of this application further provides a communication device 1000, including a processor 1001 and a memory 1002. The memory 1002 stores a program or instructions capable of running on the processor 1001. The program or the instructions are executed by the processor 1001 to implement the steps of the foregoing paging physical downlink control channel monitoring processing method embodiments, and can achieve the same technical effects. To avoid repetition, details are not described herein again.

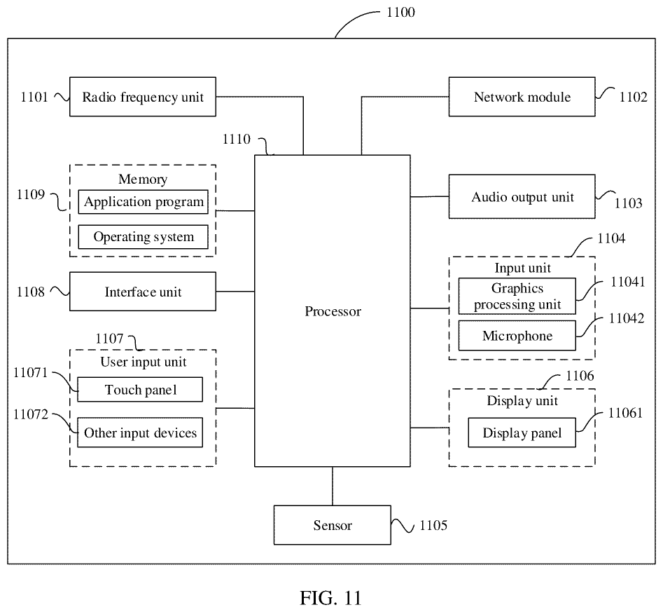

An embodiment of this application further provides a terminal, including a processor and a communication interface. The communication interface is coupled to the processor. The processor is configured to run a program or instructions to implement the steps in the method embodiment shown in FIG. 3. The terminal embodiment corresponds to the foregoing terminal side method embodiment. Each implementation process and implementation of the foregoing method embodiment may be applied to the terminal embodiment, and the same technical effects can be achieved. Specifically, FIG. 11 is a schematic diagram of a hardware structure of a terminal for implementing an embodiment of this application.

The terminal 1100 includes but is not limited to at least some components in a radio frequency unit 1101, a network module 1102, an audio output unit 1103, an input unit 1104, a sensor 1105, a display unit 1106, a user input unit 1107, an interface unit 1108, a memory 1109, a processor 1110, and the like.

A person skilled in the art may understand that the terminal 1100 may further include a power supply (for example, a battery) that supplies power to each component. The power supply may be logically connected to the processor 1110 by using a power management system, to implement functions such as charging management, discharging management, and power consumption management through the power management system. The structure of the terminal shown in FIG. 11 does not constitute a limitation on the terminal. The terminal may include more or fewer components than those shown in the figure, or combine some components, or have different component arrangements. Details are not described herein again.

It should be understood that in this embodiment of this application, the input unit 1104 may include a Graphics Processing Unit (GPU) 11041 and a microphone 11042, and the graphics processing unit 11041 processes image data of a still picture or a video obtained by an image capture apparatus (for example, a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 or other input devices 11072. The touch panel 11071 is also referred to as a touchscreen. The touch panel 11071 may include two parts: a touch detection apparatus and a touch controller. The other input devices 11072 may include but are not limited to a physical keyboard, a function key (such as a volume control key or an on/off key), a trackball, a mouse, and a joystick. Details are not described herein again.

In this embodiment of this application, after receiving downlink data from a network side device, the radio frequency unit 1101 may transmit the downlink data to the processor 1110 for processing. In addition, the radio frequency unit 1101 may send uplink data to a network side device. Generally, the radio frequency unit 1101 includes but is not limited to an antenna, an amplifier, a transceiver, a coupler, a low-noise amplifier, a duplexer, and the like.

The memory 1109 may be configured to store a software program or instructions and various types of data. The memory 1109 may mainly include a first storage area for storing a program or instructions and a second storage area for storing data. The first storage area may store an operating system, an application program or instructions required by at least one function (for example, a sound play function or an image play function), and the like. In addition, the memory 1109 may include a volatile memory or a nonvolatile memory. The nonvolatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1109 in this embodiment of this application includes but is not limited to these memories and any other suitable type of memory.

The processor 1110 may include one or more processing units. Optionally, the processor 1110 integrates an application processor and a modem processor. The application processor mainly processes operations related to an operating system, a user interface, an application program, and the like. The modem processor mainly processes a wireless communication signal, such as a baseband processor. It can be understood that, the foregoing modem processor cannot be integrated into the processor 1110.

The radio frequency unit 1101 is configured to monitor a paging physical downlink control channel PDCCH based on a target monitoring occasion set when a terminal receives a wake up signal.

The target monitoring occasion set includes monitoring occasions in a target search space set, the target search space set includes a target PDCCH search space set, or the target search space set includes a target PDCCH search space set and a paging search space set, and the target PDCCH search space set includes at least one of the following:
a PDCCH search space set for scheduling a system information block 1;
a PDCCH search space set for scheduling a system information block other than the system information block 1; or
a PDCCH search space set for scheduling a random access channel RACH response.

Optionally, the radio frequency unit 1101 is specifically configured to monitor the paging PDCCH on a target monitoring occasions in the target monitoring occasion set.

The target monitoring occasions meet at least one of the following:
the target monitoring occasions are monitoring occasions after a first moment, the first moment is after a second moment at which the terminal receives the wake up signal, and an interval between the first moment and the second moment is predetermined duration; or
the target monitoring occasions are monitoring occasions corresponding to all synchronization signal blocks in a target synchronization signal block set, and a target synchronization signal block is a synchronization signal block specified in a protocol or indicated by a network side device.

Optionally, the target monitoring occasions further meet:
the target monitoring occasions are first N monitoring occasions starting from the first moment.

Herein, N is a positive integer.

Optionally, the wake up signal is used to indicate at least one of the following:
monitoring the paging PDCCH by the terminal based on the target monitoring occasion set; or
at least one search space set in the target monitoring occasion set, where the at least one search space set is used to monitor the paging PDCCH.

Optionally, the radio frequency unit 1101 is specifically configured to monitor the paging PDCCH on the target monitoring occasions in the target monitoring occasion set, where the target monitoring occasions are determined based on a target time period, and a start moment of the target time period is any one of the following:
a time at which the terminal receives a target signal most recently; and
a time of uplink sending triggered by the target signal received by the terminal most recently.

The target signal is a radio resource control RRC release signal, a paging signal, or a wake up signal.

Optionally, the target monitoring occasions meet at least one of the following:
in the target time period, the target monitoring occasions are monitoring occasions in the paging search space set; or
after an end moment of the target time period, the target monitoring occasions are monitoring occasions in the PDCCH search space set for scheduling the system information block 1.

Optionally, the radio frequency unit 1101 is further configured to: after the terminal receives the wake up signal, obtain, from a physical broadcast channel, the PDCCH search space set for scheduling the system information block 1.

It may be understood that, for implementation processes of the implementations mentioned in this embodiment, refer to related descriptions in the method embodiment shown in FIG. 3, and same or corresponding technical effects are achieved. To avoid repetition, details are not described herein again.

An embodiment of this application further provides a network side device, including a processor and a communication interface. The communication interface is coupled to the processor. The processor is configured to run a program or instructions to implement the steps in the method embodiment shown in FIG. 7. The network side device embodiment corresponds to the foregoing method embodiment for the network side device. Each implementation process and implementation of the foregoing method embodiment may be applied to the network side device embodiment, and the same technical effects can be achieved.

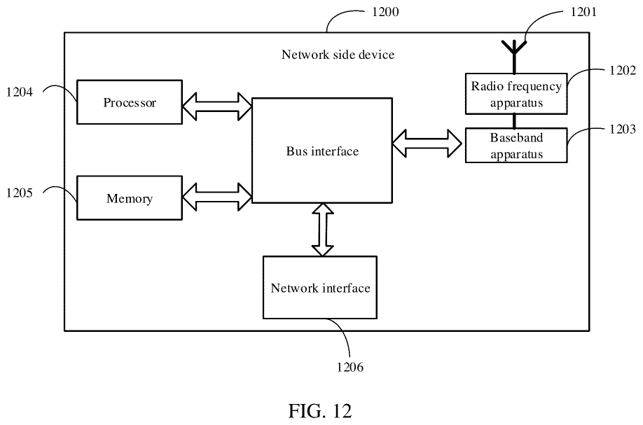

Specifically, an embodiment of this application further provides a network side device. As shown in FIG. 12, the network side device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes to-be-sent information, and sends processed information to the radio frequency apparatus 122. After processing the received information, the radio frequency apparatus 122 sends processed information through the antenna 121.

The method performed by the network side device in the foregoing embodiment may be implemented in the baseband apparatus 123. The baseband apparatus 123 includes a baseband processor.

For example, the baseband apparatus 123 may include at least one baseband board. A plurality of chips are disposed on the baseband board. As shown in FIG. 12, one of the chips is, for example, the baseband processor, and is connected to the memory 125 by using a bus interface, to invoke a program in the memory 125 to perform an operation of a network device shown in the foregoing method embodiment.

The network side device may further include a network interface 126, and the interface is, for example, a Common Public Radio Interface (CPRI).

The network side device 1200 in this embodiment of this application further includes instructions or a program stored in the memory 125 and capable of running on the processor 124. The processor 124 invokes the instructions or the program in the memory 125 to perform the method performed by the modules shown in FIG. 9, and same technical effects are achieved. To avoid repetition, details are not described herein again.

An embodiment of this application further provides a readable storage medium. The readable storage medium stores a program or instructions. The program or instructions are executed by a processor to implement the processes in the foregoing paging physical downlink control channel monitoring processing method embodiment, and same technical effects can be achieved. To avoid repetition, details are not described herein again.

The processor is a processor in the terminal described in the foregoing embodiments. The readable storage medium includes a computer-readable storage medium such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface. The communication interface is coupled to the processor. The processor is configured to run a program or instructions, to implement the processes in the paging physical downlink control channel monitoring processing method embodiment, and same technical effects can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes in the paging physical downlink control channel monitoring processing method embodiment, and same technical effects can be achieved. To avoid repetition, details are not described herein again.

An embodiment of this application further provides a wireless communication system, including a terminal and a network side device. The terminal may be configured to perform the steps of the foregoing terminal side method, and the network side device may be configured to perform the steps of the foregoing network side device method.

It should be noted that in this specification, the term “include”, “comprise”, or any other variant thereof is intended to cover a non-exclusive inclusion, so that a process, method, article, or apparatus that includes a list of elements not only includes those elements but also includes other elements that are not expressly listed, or further includes elements inherent to such a process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in an order shown or discussed, and may further include performing functions in a basically simultaneous manner or in a reverse order based on the functions involved. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for instructing a terminal or a network side device to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

1. A paging physical downlink control channel monitoring processing method, comprising:
monitoring, by a terminal, a paging physical downlink control channel PDCCH based on a target monitoring occasion set when the terminal receives a wake up signal, wherein
the target monitoring occasion set comprises monitoring occasions in a target search space set, the target search space set comprises a target PDCCH search space set, or the target search space set comprises a target PDCCH search space set and a paging search space set, and the target PDCCH search space set comprises at least one of the following:
a PDCCH search space set for scheduling a system information block 1;
a PDCCH search space set for scheduling a system information block other than the system information block 1; or
a PDCCH search space set for scheduling a random access channel RACH response.

2. The method according to claim 1, wherein the monitoring, by a terminal, a paging physical downlink control channel PDCCH based on a target monitoring occasion set comprises:
monitoring, by the terminal, the paging PDCCH on target monitoring occasions in the target monitoring occasion set, wherein
the target monitoring occasions meet at least one of the following:
the target monitoring occasions are monitoring occasions after a first moment, the first moment is after a second moment at which the terminal receives the wake up signal, and an interval between the first moment and the second moment is predetermined duration; or
the target monitoring occasions are monitoring occasions corresponding to all synchronization signal blocks in a target synchronization signal block set, and a target synchronization signal block is a synchronization signal block specified in a protocol or indicated by a network side device.

3. The method according to claim 2, wherein the target monitoring occasions further meet:
the target monitoring occasions are first N monitoring occasions starting from the first moment, wherein
N is a positive integer.

4. The method according to claim 1, wherein the wake up signal is used to indicate at least one of the following:
monitoring the paging PDCCH by the terminal based on the target monitoring occasion set; or
at least one search space set in the target monitoring occasion set, wherein the at least one search space set is used to monitor the paging PDCCH.

5. The method according to claim 1, wherein the monitoring, by a terminal, a paging physical downlink control channel PDCCH based on a target monitoring occasion set when the terminal receives a wake up signal comprises:
monitoring, by the terminal, the paging PDCCH on the target monitoring occasions in the target monitoring occasion set, wherein the target monitoring occasions are determined based on a target time period, and a start moment of the target time period is any one of the following:
a time at which the terminal receives a target signal most recently; and
a time of uplink sending triggered by the target signal received by the terminal most recently; and
the target signal is a radio resource control RRC release signal, a paging signal, or a wake up signal.

6. The method according to claim 5, wherein the target monitoring occasions meet at least one of the following:
in the target time period, the target monitoring occasions are monitoring occasions in the paging search space set; or
after an end moment of the target time period, the target monitoring occasions are monitoring occasions in the PDCCH search space set for scheduling the system information block 1.

7. The method according to claim 1, wherein before the monitoring, by a terminal, a paging physical downlink control channel PDCCH based on a target monitoring occasion set, the method further comprises:
after the terminal receives the wake up signal, obtaining, by the terminal from a physical broadcast channel, the PDCCH search space set for scheduling the system information block 1.

8. A paging physical downlink control channel monitoring processing method, comprising:
sending, by a network side device, a wake up signal to a terminal, wherein the wake up signal is used to indicate at least one of the following:
monitoring of a paging physical downlink control channel PDCCH based on a target monitoring occasion set; or
at least one search space set in the target monitoring occasion set, wherein the at least one search space set is used to monitor the paging PDCCH; and
the target monitoring occasion set comprises monitoring occasions in a target search space set, the target search space set comprises a target PDCCH search space set, or the target search space set comprises a target PDCCH search space set and a paging search space set, and the target PDCCH search space set comprises at least one of the following:
a PDCCH search space set for scheduling a system information block 1;
a PDCCH search space set for scheduling a system information block other than the system information block 1; or
a PDCCH search space set for scheduling a random access channel RACH response.

9. The method according to claim 8, wherein the method further comprises:
sending, by the terminal based on a physical broadcast channel, the PDCCH search space set for scheduling the system information block 1.

10. A terminal, comprising a processor and a memory, wherein the memory stores a program or instructions capable of being run on the processor, and when executed by the processor, the program or the instructions implement a paging physical downlink control channel monitoring processing method, and
wherein the method comprises:
monitoring, by the terminal, a paging physical downlink control channel PDCCH based on a target monitoring occasion set when the terminal receives a wake up signal, wherein
the target monitoring occasion set comprises monitoring occasions in a target search space set, the target search space set comprises a target PDCCH search space set, or the target search space set comprises a target PDCCH search space set and a paging search space set, and the target PDCCH search space set comprises at least one of the following:
a PDCCH search space set for scheduling a system information block 1;
a PDCCH search space set for scheduling a system information block other than the system information block 1; or
a PDCCH search space set for scheduling a random access channel RACH response.

11. The terminal according to claim 10, wherein the monitoring, by the terminal, a paging physical downlink control channel PDCCH based on a target monitoring occasion set comprises:
monitoring, by the terminal, the paging PDCCH on target monitoring occasions in the target monitoring occasion set, wherein
the target monitoring occasions meet at least one of the following:
the target monitoring occasions are monitoring occasions after a first moment, the first moment is after a second moment at which the terminal receives the wake up signal, and an interval between the first moment and the second moment is predetermined duration; or
the target monitoring occasions are monitoring occasions corresponding to all synchronization signal blocks in a target synchronization signal block set, and a target synchronization signal block is a synchronization signal block specified in a protocol or indicated by a network side device.

12. The terminal according to claim 11, wherein the target monitoring occasions further meet:
the target monitoring occasions are first N monitoring occasions starting from the first moment, wherein
N is a positive integer.

13. The terminal according to claim 10, wherein the wake up signal is used to indicate at least one of the following:
monitoring the paging PDCCH by the terminal based on the target monitoring occasion set; or
at least one search space set in the target monitoring occasion set, wherein the at least one search space set is used to monitor the paging PDCCH.

14. The terminal according to claim 10, wherein the monitoring, by a terminal, a paging physical downlink control channel PDCCH based on a target monitoring occasion set when the terminal receives a wake up signal comprises:
monitoring, by the terminal, the paging PDCCH on the target monitoring occasions in the target monitoring occasion set, wherein the target monitoring occasions are determined based on a target time period, and a start moment of the target time period is any one of the following:
a time at which the terminal receives a target signal most recently; and
a time of uplink sending triggered by the target signal received by the terminal most recently; and
the target signal is a radio resource control RRC release signal, a paging signal, or a wake up signal.

15. The terminal according to claim 14, wherein the target monitoring occasions meet at least one of the following:
in the target time period, the target monitoring occasions are monitoring occasions in the paging search space set; or
after an end moment of the target time period, the target monitoring occasions are monitoring occasions in the PDCCH search space set for scheduling the system information block 1.

16. The terminal according to claim 10, wherein before the monitoring, by the terminal, a paging physical downlink control channel PDCCH based on a target monitoring occasion set, the method further comprises:
after the terminal receives the wake up signal, obtaining, by the terminal from a physical broadcast channel, the PDCCH search space set for scheduling the system information block 1.

17. A network side device, comprising a processor and a memory, wherein the memory stores a program or instructions capable of being run on the processor, and when executed by the processor, the program or the instructions implement the steps of the paging physical downlink control channel monitoring processing method according to claim 8.

18. The network side device according to claim 17, wherein the method further comprises:
sending, by the terminal based on a physical broadcast channel, the PDCCH search space set for scheduling the system information block 1.

19. A non-transitory readable storage medium, wherein the readable storage medium stores a program or instructions, and when executed by a processor, the program or the instructions implement the steps of the paging physical downlink control channel monitoring processing method according to claim 1.

20. A non-transitory readable storage medium, wherein the readable storage medium stores a program or instructions, and when executed by a processor, the program or the instructions implement the steps of the paging physical downlink control channel monitoring processing method according to claim 8.
